(19) United States
(12) Patent Application Publication
(10) Pub. No.: US 2025/0285283 A1
(43) Pub. Date: Sep. 11, 2025

(54) IMAGE LABEL SHARING SYSTEM

(71) Applicant: GE Precision Healthcare LLC, Waukesha, WI (US)

(72) Inventors: Deepa Anand, Bengaluru (IN); Bipul Das, Chennai (IN); Antony Jerald, Kottayam (IN); Rakesh Mullick, Bengaluru (IN); Vyshnav Dangeti, Anakapalle (IN)

(21) Appl. No.: 18/952,020

(22) Filed: Nov. 19, 2024

(30) Foreign Application Priority Data
Mar. 6, 2024 (IN) 202441015934

(51) Int. Cl. G06T 7/11

(52) U.S. Cl. CPC G06T 7/11

(57) ABSTRACT

Various systems and methods are presented regarding segmentation of medical images whereby a segmentation process comprises of channels configured to share labels. Accordingly, rather than each label in a series of images all requiring an individual channel in a segmentation model, the segmentation model can be configured such that a single channel (e.g., having a single group of labels) is shared by images having multiple labels. By sharing a channel, and label group, across multiple labels, the efficiency of the segmentation model is improved as fewer channels are required to segment a series of images. Matching between regions of interest across the series of images can be performed to determine a number of shared channels required for the segmentation model. The series of images can be further applied to the segmentation model to generate a set of labeled segmented images.

### CROSS-REFERENCE TO RELATED APPLICATIONS

This application claims priority to India Provisional Patent Application No. 202441015934 filed on Mar. 6, 2024, entitled “IMAGE LABEL SHARING SYSTEM”. The entireties of the aforementioned application are incorporated by reference herein.

### TECHNICAL FIELD

This application relates to systems and techniques facilitating segmentation imaging in a biomedical imaging system.

### BACKGROUND

Segmentation tasks and deep learning methods can be utilized for biomedical imaging applications, whereby, such tasks and methods can involve analyzing/processing images of multiple anatomies. As part of such processes, each anatomy image can be annotated with one or more labels identifying one or more regions of interest. Labelling of the regions can be a complex task requiring multiple parameters, and/or channels, in accordance with the number of images and associated labelled regions.

The above-described background is merely intended to provide a contextual overview of some current issues and is not intended to be exhaustive. Other contextual information may become further apparent upon review of the following detailed description.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. The sole purpose of the Summary is to present some concepts of the disclosure in a streamlined form as a prelude to the more detailed description that is presented later.

In one or more embodiments described herein, systems, devices, computer-implemented methods, configurations, apparatus, and/or computer program products are presented to generate segmented images utilizing a segmentation model having fewer output channels than utilized with a conventional approach.

According to one or more embodiments, a system is presented, wherein the system comprises at least one processor, and at least one memory coupled to the at least one processor and having instructions stored thereon, wherein the system can be configured to generate segmented images from a segmentation model utilizing a number of channels matching a number of common label groups. In response to the at least one processor executing the instructions, the instructions facilitate performance of operations, comprising receiving a set of images, wherein the set of images comprises: a first image having a first region of interest (RoI), wherein the first image is associated with a first task, and a second image having a second RoI, wherein the second image is associated with a second task, and the first RoI and the second RoI are included in a common shared label group. In a further embodiment, the operations can further comprise applying the set of images to a segmentation model, wherein the segmentation model is a computer-implemented segmentation model and comprises an output channel configured to output segmented images based the common shared label group. In another embodiment, the operations can further comprise outputting, based on the common shared label group, at least one segmented image comprising the first RoI or the second RoI.

In an embodiment, the common label group is a first label group, the output channel is a first output channel, and at least one segmented image is included in a first set of segmented images, wherein the operations further comprise receiving a second set of images sharing a second shared label group, wherein the first shared label group and the second shared label group are disparate, and the second set of images comprises: a third image having a third RoI, wherein the third image is associated with the first task and a fourth image having a fourth RoI, wherein the fourth image is associated with the second task, and the third RoI and the fourth RoI are included in a second shared label group. Further applying the second set of images to the segmentation model, wherein the segmentation model further comprises a second output channel configured to output segmented images based on the second shared label group, and further outputting, based on the second shared label group, at least one segmented image comprising the third RoI or the fourth RoI.

In another embodiment, an architecture of the segmentation model is common to application of two or more segmentation tasks and generation of segmented images based on the first shared label group and the second shared label group.

In a further embodiment, a set of common weightings are applied during creation of both the first shared label group and the second shared label group during application of two or more segmentation tasks.

In another embodiment, labels in the first shared label group are disparate to the labels in the second shared label group.

In another embodiment, the operations can further comprise determining a first number of shared label groups in the first task and a second number of shared label groups in the second task, and further, in response to a determination that the first number of shared label groups is different to the second number of shared label groups, configuring the number of output channels of the segmentation model to equal the greater of the first number of shared label groups or the second number of shared label groups.

In an embodiment, the operations can further comprise generating the common shared label group as a function of at least one similarity between the at least two images.

In another embodiment, the operations further comprise applying a third task to the segmentation model, further generating at least one shared label group from the third task, wherein the at least one shared label group includes the common shared label group, and further training the segmentation model across multiple tasks incrementally utilizing any of the at least two images or the common shared label group.

In a further embodiment, the operations can further comprise subsequently applying a subsequent task to the segmentation model to facilitate incremental training of the segmentation model over a series of iterations to adapt the segmentation model to the subsequent task, and maintaining incremental training until determining convergence has occurred.

In another embodiment, the operations can further comprise re-applying a prior task to the converged segmentation model to prevent catastrophic forgetting of the prior task as a function of the segmentation model being converged with the subsequent task.

In further embodiments, a computer-implemented method is provided, wherein the method comprises receiving, by a device comprising at least one processor, a first image comprising a first segmentation label associated with a first region of interest (RoI), wherein the first segmentation label is included in a first shared label group. The operations can further comprise receiving, by the device, a second image, wherein the second image comprises a second RoI and a second segmentation label associated with the second RoI, further determining, by the device, whether the second RoI relates to the first RoI, and further, in response to determining, by the device, the second RoI is related to the first RoI, applying, by the device, the second segmentation label to the first shared label group.

In an embodiment, the first shared label group is associated with a first channel assigned to a segmentation model implemented by the device, wherein the segmentation model is implemented by the device to determine the second RoI is related to the first RoI.

In another embodiment, in response to determining by the device, the second RoI is unrelated to the first RoI, the computer-implemented method further comprising identifying, by the device, a third image comprising a third segmentation label, wherein the third segmentation label is associated with a third RoI and the third segmentation label is included in a second shared label group. Further determining, by the device, the second RoI relates to the third RoI, and further applying the second segmentation label to the second shared label group, wherein the second shared label group is associated with a second channel assigned to the segmentation model implemented by the device, wherein the segmentation model is implemented by the device to determine the second RoI is related to the third RoI.

In another embodiment, in response to determining by the device, the second RoI is unrelated to the first RoI and is also unrelated to the third RoI, the computer-implemented method further comprising updating, by the device, the segmentation model to include a third channel, wherein the third channel is assigned with a third shared label group, and further assigning the second segmentation label to the third shared label group.

In an embodiment, the segmentation model can be a U-net model.

In another embodiment, wherein the determination, by the device, of the second RoI relates to the first RoI is based on at least one of similarity of shape of the first RoI to the second RoI, pixel level between the first RoI and the second RoI, or patch level between a first region of interest (RoI) and a secondRoI.

Further embodiments can include a computer program product stored on a non-transitory computer-readable medium and comprising machine-executable instructions, wherein, in response to being executed, the machine-executable instructions cause a system to perform operations, comprising receiving a set of images, wherein the set of images comprises a first image having a first region of interest (RoI), wherein the first image is associated with a first task, and a second image having a second RoI, wherein the second image is associated with a second task, and the first RoI and the second RoI are included in a common label group. Further applying the set of images to a segmentation model, wherein the segmentation model is a computer-implemented segmentation model and comprises an output channel configured to output segmented images based the common label group, and further outputting, based on the common shared label group, at least one segmented image comprising the first RoI or the second RoI.

In an embodiment, the set of images in the task comprise medical images.

In another embodiment, the first RoI being related to the second RoI is based on at least one of similarity of shape of the first RoI to the second RoI, pixel level between the first RoI and the second RoI, or patch level between a first RoI and a second RoI.

In a further embodiment, the operations can further comprise defining the number of output channels prior to generating the set of shared label groups.

### BACKGROUND

Technological advancements in the last years have prompted the medical world to strive for precision healthcare. The goal of precision healthcare comprises the ability for a caregiver to retrieve precise information (about the patient and/or about treatment) at the right time and place. One way in which this ability is needed relates to the time available to review a patient's medical data tends to become shorter as the workload and working requirements of medical staff increases (e.g., as radiologists and clinicians work intensifies). Another way is the need for ready and easy querying sources of information, with accurate/well considered treatment recommendations.

The above-described background is merely intended to provide a contextual overview of some current issues and is not intended to be exhaustive. Other contextual information may become further apparent upon review of the following detailed description.

### DESCRIPTION OF THE DRAWINGS

One or more embodiments are described below in the Detailed Description section with reference to the following drawings.

FIG. 1 presents a high-level overview of a segmentation system utilizing a shared-label configuration, in accordance with one or more embodiments.

FIG. 2 presents a schematic illustrating a segmentation model, in accordance with one or more embodiments.

FIG. 3 presents a sample shared label space comprising a series of shared labels for segmentation of respective example anatomies, in accordance with an embodiment.

FIG. 4 illustrates a high-level view of operation of a shared label segmentation system, in accordance with one or more embodiments.

FIG. 5 presents a schematic illustrating an example operation of a label match component, in accordance with an embodiment.

FIG. 6 presents a sequence of tasks generated by an incrementally trained segmentation model, in accordance with an embodiment.

FIG. 7 presents a set of output images from combined model inference output, after incremental learning has been performed.

FIG. 8 illustrates a computer-implemented method for applying a prompt to a question to constrain scope of question and/or supplied answer, in accordance with an embodiment.

FIG. 9 illustrates an example computer-implemented method for utilizing label sharing in an image segmentation process, in accordance with an embodiment.

FIG. 10 illustrates an example computer-implemented method for utilizing label sharing in an image segmentation process, in accordance with an embodiment.

FIG. 11 illustrates an example computer-implemented method for utilizing label sharing in an image segmentation process, in accordance with an embodiment.

FIG. 12 is a block diagram illustrating an example computing environment in which the various embodiments described herein can be implemented.

FIG. 13 is a block diagram illustrating an example computing environment with which the disclosed subject matter can interact, in accordance with an embodiment.

### DETAILED DESCRIPTION

The following detailed description is merely illustrative and is not intended to limit embodiments and/or application or uses of embodiments. Furthermore, there is no intention to be bound by any expressed and/or implied information presented in any of the preceding Background section and/or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

As used herein, “data” can comprise metadata. Further, ranges A-n and A-i are utilized herein to indicate a respective plurality of devices, components, signals etc., where n and i are any positive integers.

The various embodiments presented herein relate to a technique/method/process called “label-sharing”. As further described, each label (aka a channel) included each respective task is shared across independent segmentation tasks, such that a first label in a first task shares a channel with a second label in a second task. In an aspect, segmentation and segmentation labels relate to identifying/labeling pixels of interest versus pixels not of interest in an image.

As previously mentioned, segmentation tasks and deep learning methods can be utilized for biomedical imaging applications, whereby, such tasks and methods can involve analyzing/processing images of multiple anatomies. As part of such processes, each anatomy image can be annotated with one or more labels identifying one or more regions of interest. Labelling of the regions can be a complex task requiring multiple parameters, and/or channels, in accordance with the number of images and associated labelled regions.

Present approaches for multi-task incremental learning include (a) multi-task learning; (b) domain adaptation approaches; (c) mixture of experts; and (d) Foundation models. Approaches (a) and (c) requires a large number of output channels and, in most cases, approaches (a) and (c) do not necessarily share labels. Domain adaptation on the other hand has serious issues of catastrophic forgetting and suboptimal solution across tasks. Foundation models, while powerful, are excessively heavy, resulting in high inference costs and may not be optimal for specific task sets, as they are designed for more generalized application.

In the area of incremental learning, numerous solutions leverage textual descriptions delineating objects or regions of interest, alongside their associated embeddings, as input to a vision model for the detection of novel items or the execution of new tasks.

However, these methods rely on the availability of pretrained foundation models during inference which may not be feasible or effective for medical imaging.

In one approach, separate models can be trained for each anatomy. In another approach, a common block model for learning general features (e.g., by an encoder) followed by separate task heads for each anatomy/task (e.g. by a decoder) can be utilized. However, both approaches require additional parameters for each new task.

Another conventional approach for mitigating the requirement of additional parameters for each new task, is to use a single, common model but with different labels (also known as channels) across different anatomies. However, adoption of this approach requires an increase in the total number of channels (and parameters) for each new anatomy to be detected by the common model.

Further, with conventional approaches, in the event of a model already being trained and further performing an incremental learning process, implementation of an additional task(s) can be difficult/impossible, due to one or more changes required in the model architecture to implement the additional task(s).

### Review of a Conventional Approach

Regarding a conventional approach, in conjunction with two example operational scenarios (i) and (ii):
a) let there be ‘N’ independent tasks, where independent indicates that there is no overlap in the set of images used for any of the tasks, e.g., imagery of a hand cannot appear in both a first task and a second task concurrently applied to a segmentation model.
b) let the tasks be Tᵢ, i=1, . . . , N.
c) let the number of segmentation labels for Tᵢ be nᵢ, Lᵢⱼ being the j^{th} landmark/segmentation mask for task Tᵢ.

Accordingly, per Equation 1, the total number of labels S to be learnt by a segmentation model or a set of models will be

$$S = {\sum }_{i = 1}^{N} {n}_{i} . \qquad Eqn . 1$$

Generally, the two operational scenarios are: (i) a network has S number of channels such that, based on the choice of tasks, the set of channels are chosen as an output, or (i) a network is retrained to adapt to a new task. With the conventional approach, scenario (i) becomes unmanageable after a limited set of tasks and beyond a limited number of labels since S tends to become prohibitively large, and further, with scenario (ii), catastrophic forgetting becomes challenging.

### Label Sharing System

Per the various embodiments presented herein, a single, label sharing model is utilized with all of the parameters remaining the same for all of the respective tasks. Further, the label sharing model can be trained with the labels across multiple tasks being shared per respective label groups. For example, label L₁₃ identifying a first region of interest (RoI) in a first image can be in the same shared label group as a label L₂₁ identifying a second RoI in a second image, and so on, as further described. Hence, with the various embodiments presented herein, contrary to the conventional approach (per Equation 1) the label sharing model schema only requires, per Equation 2:

$${G = max}_{i = 1 … N} ( {n}_{i} ) number of labels or channels \qquad Eqn . 2$$

where G means grouping, as further described.

### Benefits of Utilizing a Label Sharing System

Utilizing a label sharing model as part of a segmentation process has multiple benefits over conventional approaches, such as, in a non-limiting list:

a) reduction in the number of channels from Σ₁^{N}nᵢ to

$${max}_{i = 1 … N} ( {n}_{i} ) ,$$

per Equations 1 and 2,
b) maintains a consistent set of channels across tasks,
c) is lightweight,
d) optimized for specific tasks without the potential for catastrophic forgetting,
e) enables incremental learning for additional tasks without having to change the model architecture,
f) improved speed of execution and extends existing models for implementation with additional tasks,
g) can be utilized across multiple/disparate products and use-cases of multi-label segmentation tasks,
h) modality and domain agnostic,
i) enables a training methodology to be implemented for incremental learning that ensures no forgetting of past tasks, and
j) automatically determines the labels to be shared based on landmark similarity and utilizing a matching optimization procedure.

Accordingly, the various embodiments presented herein disclose and facilitate, per (A)-(D):
A) A novel framework of a unified model for label-sharing across different multi-label segmentation tasks. The various embodiments utilize a single model architecture configured to share output labels across multiple tasks, enabling incremental learning without altering the number of output channels. Consequently, each output channel within the network is utilized for sharing labels across various tasks.
B) Transitioning from one task to another may involve training the network with the new dataset for a few epochs while selecting the suitable channels for label sharing. For instance, if the network has already been trained for M tasks, incorporating the (M+1)^{th} task entails initially training the pre-trained network for the new task, followed by additional epochs of retraining that include the previous tasks as well. Such an approach mitigates the risk of catastrophic forgetting, a prevalent issue (e.g., with a conventional approach) when introducing a new task.
C) In the context of a single network addressing multi-label segmentation across multiple tasks, the total number of output channels for the network is determined by

$${max}_{i = 1 , … , N} {n}_{i} ,$$

where i represents the task number and nᵢ is the labels corresponding to i^{th} task. This differs significantly from the conventional requirement of Σᵢ₌₁^{N}nᵢ, to stack different multi-label segmentation tasks.
D) Design of the model architecture(s) presented herein take into consideration the selection of channels for label sharing. Various systems and methods are presented for determining the optimal label-channel combinations across different tasks, aiming to share the most suitable set of labels for a given channel. The various systems and methods can utilize similarity or distance metrics calculated by (a) Foundation Model (FM) features, (b) hand-crafted features, (c) other network-based features (e.g., deep learning-network-based features), (d) employ techniques such as simulated annealing or similar methods, and suchlike. The computation of similarity can be tailored to a specific use case. The label-sharing mechanism remains resilient even when faced with a diverse range of labels.

It is to be appreciated that while the various embodiments presented herein are directed to biomedical applications, the embodiments are not so limited and can be equally applied to any application utilizing image segmentation or other applicable technology/techniques.

Accordingly, per the various embodiments presented herein, a number of common labels can be determined for a set of images in a task, wherein the various images in the set of images can include regions of interest (RoIs). The number of common labels can be established based on the number of RoIs, assigned/identified labels, etc. The number of common labels can then be applied to a segmentation model, whereby the number of common labels defines the number of output channels of the segmentation model. Further images can be subsequently processed and further utilized to confirm that the segmentation model is performing correctly with the current combination of common labels and output channels. In the event of the segmentation model is not performing as expected, the number of common labels can be reassessed and the segmentation model updated accordingly.

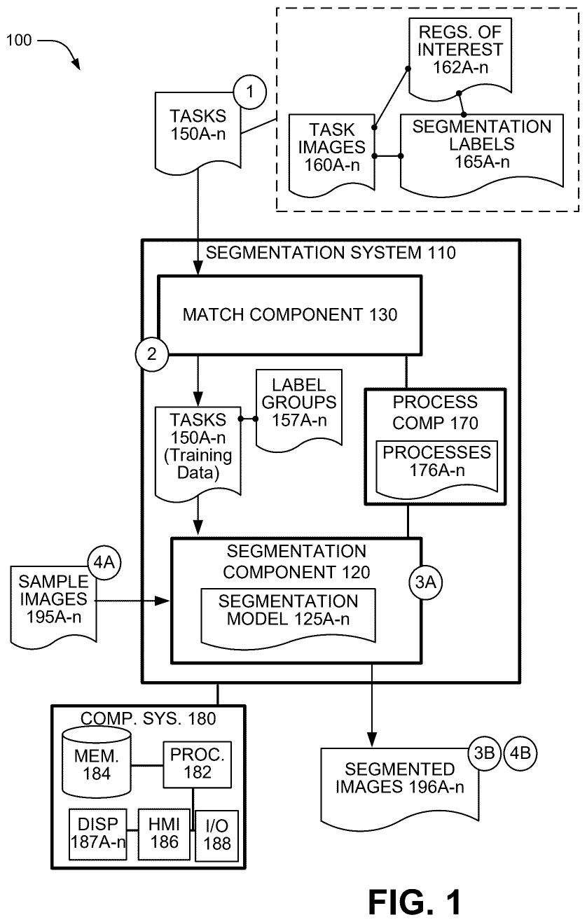

FIG. 1, system 100, presents a high-level overview of a segmentation system utilizing a shared-label configuration, in accordance with one or more embodiments. As shown in FIG. 1, a segmentation system 110 can be configured to generate parameter optimized shared labels for independent multi-anatomy segmentation and incremental learning. Segmentation system 110 can be configured to receive a set of tasks 150A-n, wherein, per the various embodiments presented herein, tasks 150A-n can comprise a set of images 160A-n (a.k.a., task images) wherein each image in the set of images 160A-n has been previously annotated with one or more labels 165A-n indicating respective regions of interest (RoI) 162A-n on the respective images 160A-n. Labels 165A-n for RoIs 162A-n can be generated by subject matter experts, e.g., by a human entity annotating the images 160A-n (e.g., using a digital pen), and can further provide ground truth information to a supervised machine learning algorithm (e.g., segmentation model 125A-n, as further described).

Segmentation system 110 can comprise any suitable architecture and further include a segmentation component 120 configured to perform biomedical image segmentation. In an embodiment, segmentation component 120 can be configured to utilize one or more segmentation models 125A-n. Any suitable segmentation model 125A-n can be utilized for image segmentation of the various tasks 150A-n. For example, segmentation model 125A-n can be an artificial neural network, a convolutional neural network, a fully convolutional network, a diffusion model, and suchlike. Tasks 150A-n comprising the images 160A-n, RoIs 162A-n, and labels 165A-n can be utilized by the segmentation component 120 to train the segmentation model 125A-n. Segmentation model 125A-n can be provided by process component 170, wherein segmentation model 125A-n can be included in processes 176A-n, as further described.

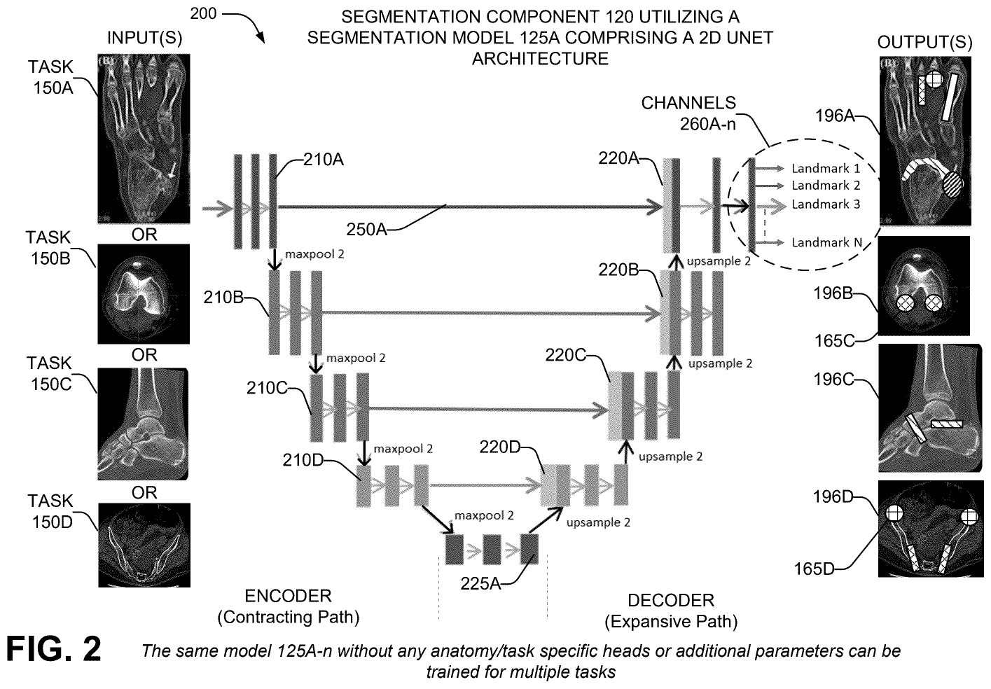

In an example embodiment, segmentation model 125A-n can be a convolutional neural network having a U-net configuration, e.g., a U-shaped encoder/decoder architecture. Turning briefly to FIG. 2, schematic 200 illustrates segmentation model 125A-n having an example U-net architecture, wherein the term “architecture” relates to an arrangement of deep learning tools such as convolutional layer, max pooling, etc. As shown, the example U-net architecture can be configured with a contraction/encoder path comprising a series of encoder blocks 210A-n (e.g., convolutional layers and intermediate max pool layers) and an expansion/decoder path comprising a series of decoder blocks 220A-n (e.g., convolutional layers and intermediate up sample operations), where, in the presented example configuration, U-net architecture 125A comprises four encoder blocks 210A-D and four decoder blocks 220D.

In an example operation, the U-net architecture of segmentation model 125A-n can receive a set of input tasks 150A-n, for example, a first task 150A (e.g., image 160A of a foot, axial view), a second task 150B (e.g., image 160B of a knee), a third task 150C (e.g., image 160C of a hip), a fourth task 150D (image 160D of a foot, sagittal view), and suchlike. Utilizing the encoder blocks 210A-n, U-net architecture 125A can be configured to extract one or more useful features, RoIs 162A-n, from the input image 160A-n, utilizing multiple convolutional layers. Decoder blocks 220A-n are configured to up sample the one or more RoIs 162A-n (e.g., using a transpose convolution operation in conjunction with a concatenation process). As further shown, the U-net architecture 125A generates/outputs respective segmentation masks 240A-n, e.g., demarking/outlining RoIs 162A-n. In an aspect, U-net architecture 125A can utilize connecting paths 250A-n to concatenate an output of an encoder layer as the input of a decoder layer, feeding features from one part of the encoder blocks 210A-n to decoder blocks 220A-n.

In an embodiment, as previously mentioned, during training, tasks 150A-n and respective RoIs 162A-n on the sample images 160A-n, can be labelled/annotated with labels 165A-n. When using a conventional approach, each label 165A-n on each sample image 160A-n requires an independent channel 260A-n as an output of the segmentation model 125A-n. Per the various embodiments presented herein, by sharing labels 165A-n across the RoIs 162A-n, images 160A-n and tasks 150A-n, the number of channels 260A-n required for outputs of the segmentation model 125A-n can be reduced. And further, when utilizing a segmentation model 125A-n with parameter optimized shared labels 165A-n, incremental learning can be implemented. With the segmentation model 125A-n trained with tasks 150A-n, sample images/tasks 195A-n can be applied to the segmentation model 125A-n, with trained segmentation model 125A-n further configured to generate/output segmented images 240A-n. It is to be appreciated that given the limits of rendering images in black and white, the respective shading of the RoIs 162A-n in the various FIGS. 2-4, 6, and 7 is not consistent and arbitrary shading is being utilized to convey distinct RoIs 162A-n, labels 165A-n, being implemented on respective images in accordance with the various embodiments presented herein.

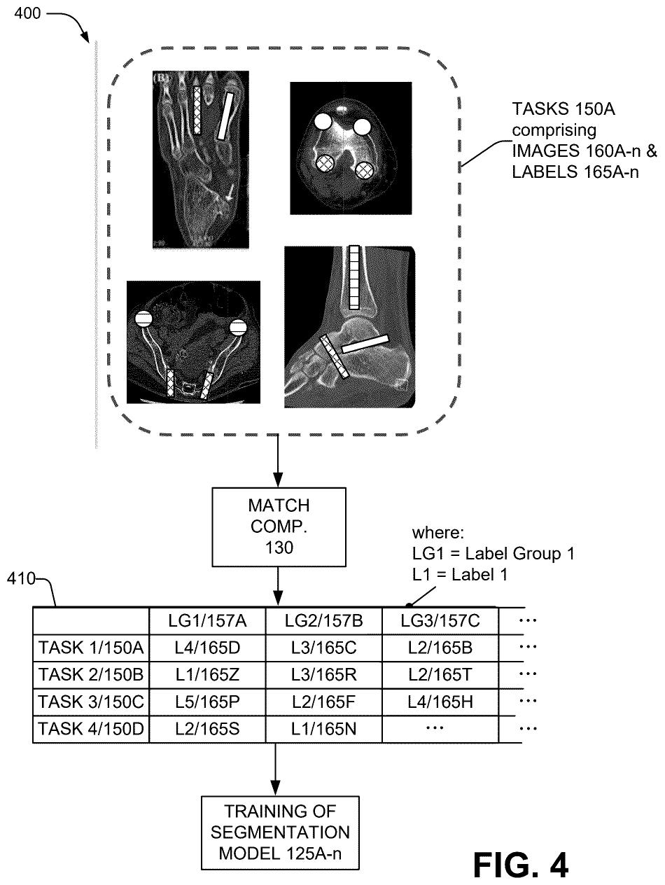

FIG. 1 presents a series of steps 1-4B presenting a high-level overview of a sequence of operations that can be implemented with segmentation system 110 and system 100 generally, the steps are further described per FIG. 4.

At step 1, a series of tasks 150A-n can be received at segmentation system 110, wherein the tasks 150A-n include a collection of sample images 160A-n having RoIs 165A-n, wherein the respective RoIs 165A-n are respectively labelled with labels 165A-n.

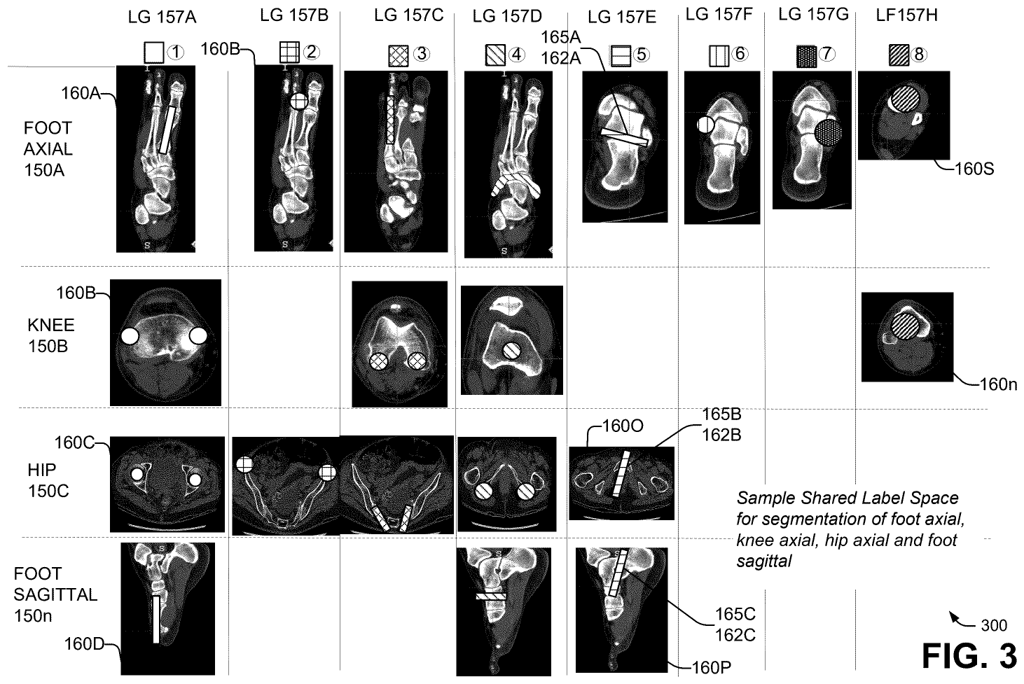

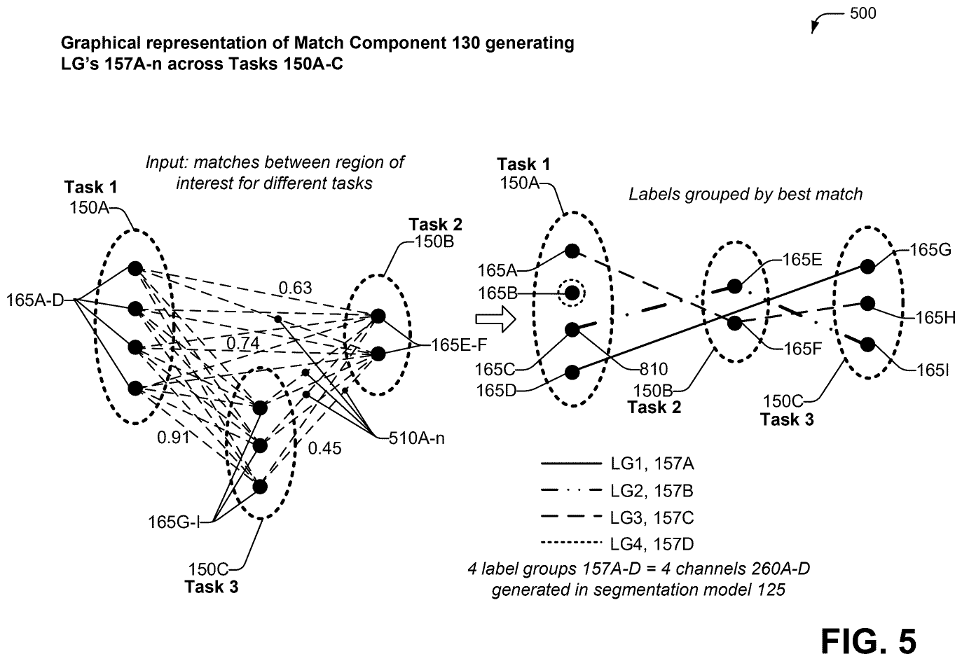

At step 2, the tasks 150A-n are applied to the match component 130 configured to match respective labels 165A-n into a collection of label groups 157A-n (e.g., per FIGS. 3 and 5).

At step 3A, the tasks 150A-n with labels 165A-n in images 160A-n respectively assigned to the two or more label groups 157A-n are applied to the segmentation model 125A, wherein segmentation model 125A generates/outputs the segmented images 196A-n per the respective label groups 157A-n.

At step 3B, the segmented images 196A-n can be reviewed for correctness (e.g., correctly labelled RoIs 162A-n and label groupings 157A-n). In response to determining the segmented images 196A-n are as expected, the match component 130 and segmentation model 125A can be considered to be operating correctly/trained, e.g., the determined number of group labels 157A-n generated by the match component 130 enables the segmentation model 125A to correctly generate/label the segmented images 196A-n. In the event of the segmented images 196A-n are not as expected, steps 1-3B can be re-performed.

At step 4A, sample tasks/images 195A-n (e.g., comprising actual data/RoIs/labels comparable to RoIs 162A-n and labels 165A-n) can be applied to the trained segmentation model 125A, wherein the segmentation component 125A generates segmented images 196A-n from the sample images 195A-n.

At step 4B, the segmented images 196A-n generated from the sample images 195A-n can be reviewed for correctness. In response to a determination that the segmented images 196A-n are being generated correctly, steps 4A and 4B can be repeated. In response to a determination that the segmented images 196A-n are being incorrectly generated (e.g., the number of label groups 157A-n is no longer sufficient) the match component 130 and/or the segmentation model 125A-n can be retrained.

As further shown in FIG. 1, segmentation system 110 can be communicatively coupled to/include a computer system 180. Computer system 180 can include a memory 184 that stores the respective computer executable components (e.g., segmentation component 120, match component 130, process component 170, and suchlike, as further described herein) and further, a processor 182 configured to execute the computer executable components stored in the memory 184. Memory 184 can be further configured to store any of respective tasks 150A-n, images 160A-n, RoIs 162A-n, labels 165A-n, processes 176A-n, sample images 195A-n, segmented images 196A-n, label groups 157A-n, models 125A-n, matrix 410, vector pairings 510A-n, and suchlike.

The computer system 180 can further include a human machine interface (HMI) 186 (e.g., a display, a graphical-user interface (GUI)) which can be configured to present various information including tasks 150A-n, images 160A-n, labels 165A-n, model 125A-n, label groups 157A-n, vector pairings 510A-n, and suchlike, per the various embodiments presented herein. HMI 186 can include an interactive display/screen 187 to present the various information. Computer system 180 can further include an I/O component 188 to receive and/or transmit respectively newly defined tasks 150A-n, images 160A-n, RoIs 162A-n, labels 165A-n, model 125A-n, label groups 157A-n, vector pairings 510A-n, and suchlike. Any suitable technology can be utilized for interaction/communication by I/O 188, e.g., file transfer protocol (FTP), simple radio standalone (SRS), and suchlike.

### Examples of Shared Labelling Across Series of Anatomy Images

FIG. 3 presents an example sample shared label space 300 comprising a series of shared labels 157A-n for segmentation of respective example anatomies. FIG. 3 presents a set of example tasks 150A-n comprising images 160A-n with labels 165A-n (RoIs 162A-n identified). The example tasks 150A-n are presented horizontally, such that images 160A-n pertaining to a first task are presented in FIG. 3 on the horizontal. For example, images 160A to 160R on the horizontal pertain to foot axial task 150A. Further, images 160 to 160n on the horizontal pertain to knee task 150B, hip task 150C comprises images 160C to 1600, and foot sagittal task 150n comprises images 160D to 160P.

Further shown in FIG. 3 are a series of shared label groups 157A-n, aligned vertically in FIG. 3. For example, eight shared label groups 157A-n are utilized across the set of tasks 150A-n. For example, a first shared label 157A (red) is used to label/annotate a respective region on each of tasks 160A-n. Shared Label 157B (green) is used to label regions on both foot axial and hip tasks 150A and 150n. Shared Label 157C (blue) is used to label regions on foot axial, knee, and hip tasks 150A, 150B, and 150C. Shared Label 157D (purple) is used to label regions on foot axial, knee, hip, and foot sagittal tasks 150A-n. Shared Label 157E (orange) is used to label regions on foot axial, hip, and foot sagittal tasks 150A, 150C, and 150n. Shared Label 157F (light green) is used to label a region on an image in the foot axial task 150A. Shared Label 157G (mauve) is used to label a region on an in foot axial task 150A. Shared Label 157H (peach) is used to label regions on foot axial and knee tasks 150A and 150B.

The concept of common labelling is further presented per the fifth column having the shared label 157E, whereby tasks 150A, 150C, and 150n are presented with corresponding RoIs 162A-C and labels 165A-C indicated. While not shown for the other columns of shared labels 157A-D and 157F-n, similar labeling 165A-n for tasks 150A-n can be applied to the respective RoIs 162A-n.

Accordingly, as presented in FIG. 3 and as further described, only eight shared label groups 157A-H and a corresponding eight channels 260A-n (in the segmentation model 125A) are required. However, with a conventional approach, where each distinct region 162A-n on each distinct image 160A-n would require a unique label and an associated channel, at least 20 channels would be required as outputs of the segmentation model 125A-n, where each channel corresponds to each label in the twenty tasks 150A-n.

### Example Process Workflow

FIG. 4, schematic 400 illustrates a high-level view of operation of a shared label segmentation system, in accordance with one or more embodiments.

A series of tasks 150A-n (and associated images 160A-n) are provided to a match component 130, wherein match component 130 can be configured to group individual labels 165A-n of respective images 160A-n in tasks 150A-n into the label groups 157A-n (also referred to as LG 1-n). As shown, match component 130 can utilize a database/matrix 410, wherein the matrix 410 can be populated by the match component 130. In the example presented:
Label Group 1/157A comprises: label L4/165D of task 1 (task 150A), label L1/165Z of task 2 (task 150B), label L5/165P of task 3 (task 150C), and label 2/165S of task 4 (task 150D);
Label Group 2/157B comprises: label L3/165C of task 1, label L3/165R of task 2, label L2/165F of task 3, and label L1/165N of task 4; and
Label Group 3/157C comprises: label L2/165B of task 1, label L2/165T of task 2, and label L4/165H of task 3.

In an example embodiment, the respective steps in the process workflow are:
a) let the tasks 150A-n be Tᵢ, i=1, . . . , N and let the number of segmentation labels for each Tᵢ be nᵢ, with Ly being label corresponding to the j^{th} landmark for i^{th} task.
b) a sample data from the training set consisting of M representative samples (e.g., images 160A-n) along with their different segmentation labels (e.g., labels 165A-n) is presented to the match component 130. Match component 130 is configured to determine an optimal matching between respective labels 160A-n for different tasks 150A-n. In an embodiment, match component 130 can be configured to operate in conjunction with process component 170 utilizing one or more processes 176A-n to perform the similarity matching (e.g., between and/or across RoIs 162A-n). Different options for design and operation of the match component 130 are further described in FIG. 5.
c) In an embodiment, match component 130 can be further configured to generate output of a set of label groups 157A-n, where a label group denotes a respective RoI 162A-n for each task 150A-n having the same shared label 157A-n. Parameter (denotes a label group 157A-n, wherein the number of label groups is

$${G = max}_{i = 1 … N} ( {n}_{i} ) .$$

d) in a further embodiment, based on assigning the same shared labels 157A-n for each task 150A-n, and applying the one or more tasks 150A-n to a segmentation component 120, segmentation model 125A-n can be generated/trained. In a further embodiment, the segmentation component 120 and segmentation model 125A-n, configured with a number G output channels 260A-n, can be trained.
e) during an inference time period, the interpretation of the shared labels 157A-n by the segmentation component 120 is performed with the assumption that the input task type is known.

### Example Operation of a Match Component

FIG. 5, schematic 500, illustrates an example operation of match component 130, in accordance with an embodiment. As previously mentioned, match component 130 can be configured to match labels 165A-n (pertaining to respective images 160A-n in tasks 150A-n) and further group the matched labels 165A-n in label groups 157A-n. Match component 130 can be configured to receive a set of tasks 150A-n comprising respective images 160A-n respectively labelled with labels 165A-n pertaining to RoIs 162A-n. In an embodiment, match component 130 can be further configured to perform similarity analysis (or any other applicable technology) on the respective labels 165A-n and associated RoIs 162A-n across the respective images 160A-n in tasks 150A-n, to generate respective similarity measures 510A-n (e.g., measures 0.63, 0.74, 0.91, 0.45, etc., between respective labels 165A-n), and based thereon, can further group matched labels 165A-n to generate label groups 157A-n. While not shown, match component 130 can be further configured to apply weightings during generation of the similarity measures 510A-n, e.g., to capture relationships between labels 165A-n during creation of the respective label groups 157A-n. For example, labels 165A-n RoIs 162A-n may have a common feature such as sample images 160A-n were generated on a common system, were not generated on a common system, RoIs 162A-n and labels 165A-n were generated by a common entity (e.g., a common system, the same human reviewer), and suchlike. Per the following schemes 1-3, when, for example, a common U-net based architecture is trained for all tasks 150A-n but each label 165A-n from each task 150A-n retains the assigned unique label 165A-n (e.g., per a conventional, non-label sharing, unique labeling approach), the number of output channels 260A-n would therefore be Σ₁^{N}nᵢ.

The following now describes three schemes, Schemes 1-3 utilizing the parameter optimized shared label approach, per the various embodiments presented herein.

### Scheme 1

M exemplar images 160A-n containing each of the RoIs 162A-n/labels 165A-n for each of the tasks 150A-n is determined and the feature vectors (not shown) of each of these exemplar images 160A-n is derived as the intermediate representation of an encoder on one of the decoder layers.

For a label pair ‘a’ for Tᵢ and ‘b’ for T; where i≠j, the respective average similarity 510A-n of these feature vectors between images 160A-n belonging to each label group 157A-n is determined (e.g., by match component 130).

$$Match ( {T}_{ia} , {T}_{jb} ) = {mean}_{{m \to 1 to M}_{n \to 1 to M}} sim ( feat ( {T}_{ia}^{m} ) , feat ( {T}_{2 b}^{n} ) ) ,$$

where sim is the cosine similarity and feat is the features extracted from the encoder or decoder of the initial trained network.

The similarity 510A-n for different labels 165A-n across tasks 150A-n can also be derived in the following manner:

### Scheme 2:

Match component 130 can utilize an object detection model (e.g., process 176A-n, a Foundation Model (FM)) technique, configured for feature extraction at both patch and pixel levels. Accordingly, an object detection model 176A can be configured to recognize RoIs 162A-n in images 160A-n. When segmentation masks (e.g., comparable to segmentation masks 240A-n) are provided, the features of pixels (e.g., of respective RoIs 162A-n) associated with each segmentation mask within the image 160A-n can be aggregated to generate a feature vector representation (not shown) for a specific label 165A-n. Subsequently, a similarity-based method, as previously described, can be employed to ascertain matches between various RoIs 162A-n and labels 165A-n across diverse tasks 150A-n.

### Scheme 3:

Utilizing hand-crafted features like shape, texture or other image-based features corresponding to each of the RoIs 162A-n/labels 165A-n across the tasks 150A-n can be used by match component 130 to find similarity 510A-n between labels 165A-n and use similar formulation to that presented in Scheme 1.

### Label Matching Based on Similarity of RoI of Different Tasks

Once the respective similarity match degrees 510A-n have been determined between every pair of labels 165A-n across different tasks 150A-n, an optimal matching of labels 165A-n across different tasks 150A-n can be performed by match component 130. Any suitable technology/process 176A-n can be utilized by match component 130, e.g., a Hungarian algorithm for two tasks or for more complex scenarios, variants such as Integer Programming, Genetic Algorithms, Simulated Annealing for multiple sets, and suchlike can be used.

As shown in FIG. 5:
i) a first label group LG1/157A has been determined by the match component 130 and comprises label 165D (associated with RoI 162D) from task 1/150A and label 165G (associated with RoI 162G) from task 3/150C;
ii) a second label group LG2/157B comprises label 165C (associated with RoI 162C) from task 1, label 165E (associated with RoI 162E) from task 2/150B, and label 165I (associated with RoI 162I) from task 3;
iii) a third label group LG3/157C has been determined and comprises label 165A (associated with RoI 162A) from task 1, label 165F (associated with RoI 162F) from task 2, and label 165H (associated with RoI 162H) from task 3;
iv) a fourth label group LG4/157D comprises the single label 165B (associated with RoI 162B) from task 1.

Hence, while some of the labels 165A-n across the tasks 150A-n have a high similarity (e.g., in RoIs 162A-n) to enable formation of label groups 157A-n, other labels, such as label 165B (associated with RoI 162B), does not have a sufficient degree of matching 510A-n any other label 165A/165C-n (associated with RoIs 162A/C-n) and hence is a sole member of a label group, e.g., LG4/157D.

### Incremental Learning

A benefit of utilizing segmentation system 110 and the label sharing model 125A lies in the ability of the segmentation component 120 and label sharing model 125A to train the label sharing model 125A for additional independent anatomies, without necessitating architectural modifications of the label sharing model 125A. Such an approach can be contingent upon the following conditions: (i) the tasks 150A-n are independent with no anatomical overlap between them, and (ii) number of labels 165A-n for the new task 150A≤ number of existing channels 260A-n in the network 125A.

Regarding post training with a new task 150A, catastrophic forgetting for earlier/old/prior/previously applied tasks 150B-n can be circumvented by conducting combined training of previously applied tasks 150B-n and new task 150A through a sequence of iterations, e.g., 5-6 iterations. Such an approach utilizing the label sharing model 125A process enables satisfactory results to be achieved across all the tasks 150A-n.

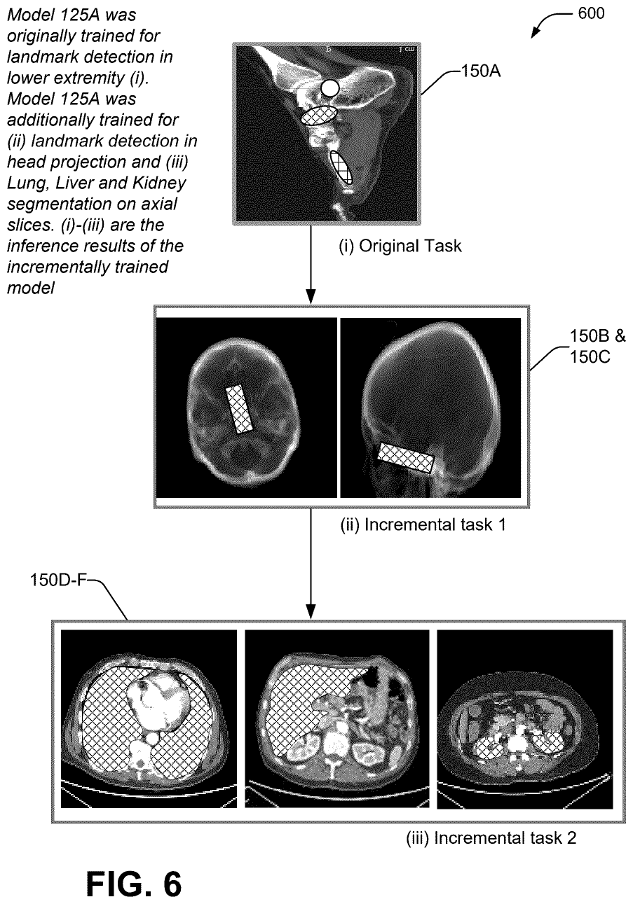

FIG. 6 presents a sequence of tasks generated by an incrementally trained segmentation model, in accordance with an embodiment. A sequence of tasks 150A-n are presented indicating results of the incremental learning process. Originally the segmentation model 125A was trained for landmark/RoI 162A-n detection in (i) a lower extremity (original task 150A). The segmentation model 125A was additionally trained for (ii) landmark/RoI 162A-n detection in head projection (incremental task 1, tasks 150B and 150C), and further trained for (iii) lung, liver and kidney segmentation on axial slices (incremental task 2, tasks 150D-F). Tasks 150A-F present the inference results from the incrementally trained segmentation model 125A, with acceptable images generated for tasks 150A-F, per the various embodiments presented herein. In an embodiment, incremental training can be performed until convergence of at least one of label groups 157A-n (and included tasks 150A-n), or the one or more segmented images 196A-n.

For the various embodiments presented herein regarding example tasks 150A-n, the respective imagery, etc., were accomplished using 2D network with 4L parameters, inferencing at an average time of ˜1 s on GPU and ˜2.5 s on CPU. The various embodiments can be implemented on any suitable environment, e.g., extended to 2.5D networks, 3D networks, and suchlike.

### Combined Model Inference Output-after Incremental Learning

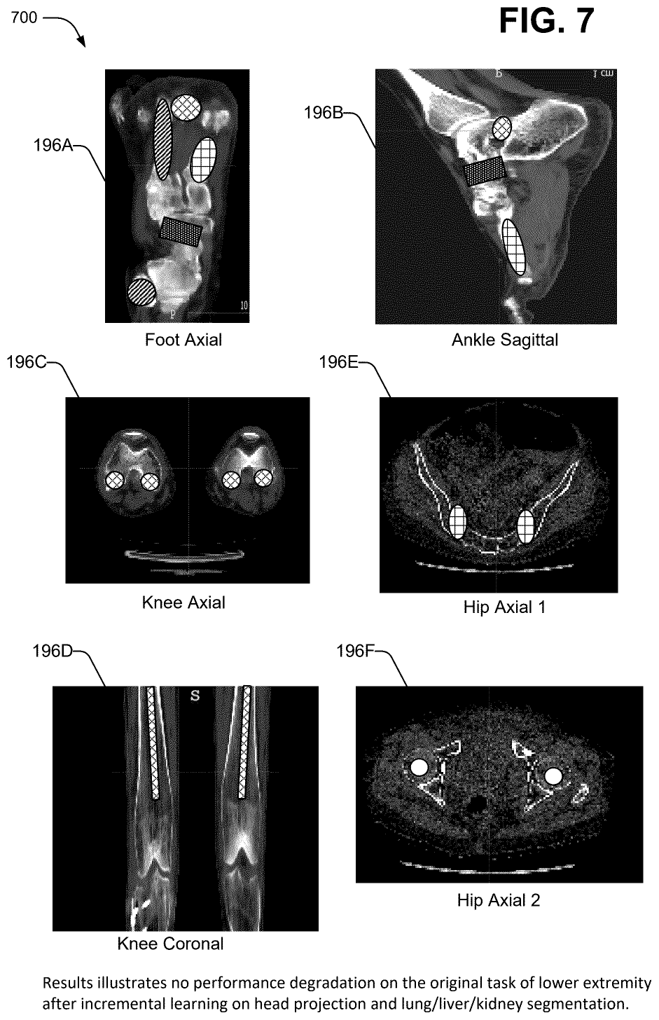

FIG. 7 presents a set of output images indicating no performance degradation resulting from application of the one or more embodiments presented herein. Images 196A-F, and can be read with the images presented in FIG. 6. Output images 196A-F were produced as a function of a combined model inference output after the incremental learning process was performed, as previously described, e.g., per FIG. 6. Output images 196A-F indicate there is no performance degradation on the original task 150A concerning a lower extremity after incremental learning has been performed on head projection tasks 150B and 150C (per FIG. 6, incremental task 1) and lung/liver/kidney tasks 150D-F segmentation (per FIG. 6, incremental task 2).

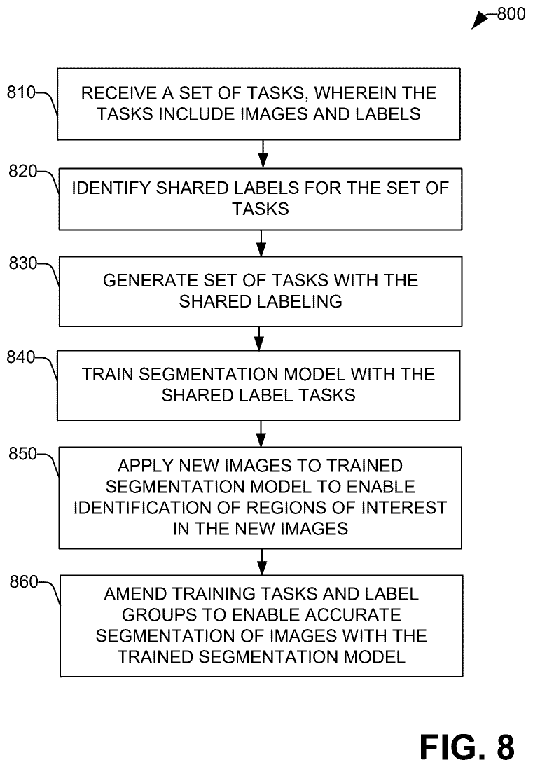

FIG. 8, via flowchart 800, presents an example computer-implemented method for utilizing label sharing in an image segmentation process, in accordance with an embodiment.

At 810, a set of tasks (e.g., tasks 150A-n) can be received at a segmentation system 110. The respective tasks can comprise images (e.g., images 160A-n) having previously applied/annotated labels (e.g., segmentation labels 165A-n) respectively identifying one or more regions of interest (e.g., RoIs 162A-n). The labels can be previously annotated by an entity (e.g., a medical expert) having knowledge to identify and label a region of interest. In an embodiment, the sample images 195A-n utilized to train the segmentation system 110, segmentation component 120, match component 130, process component 170, processes 176A-n, and such, can comprise content similar/comparable to the images 160A-n, RoIs 162A-n, and labels 165A-n in tasks 150A-n, such that sample images 195A-n can be initially utilized to train any of segmentation component 120, segmentation model 125A-n, match component 130, process component 170, and/or processes 176A-n, and once training has been performed, tasks 150A-n can be subsequently applied to segmentation system 110.

At 820, a match component (e.g., match component 130) can be configured to identify labels/RoIs on tasks having a degree of similarity such that the respective labels can be grouped (e.g., in label groups 157A-n). Any suitable measure of similarity can be utilized, e.g., a substantial level of similarity, a threshold level of similarity (e.g., as defined by a threshold measure applied to/implemented at match component 130), and the like.

At 830, the respective tasks and label groupings can be received by a segmentation component (e.g., segmentation component 120), wherein the segmentation component can apply the tasks and label groupings to a segmentation model (e.g., segmentation model 125A-n) included in the segmentation component. The segmentation model can be configured with a set of output channels (e.g., output channels 260A-n), wherein the number of output channels corresponds to the number of label groupings. The segmentation component can be further configured to generate segmented images (e.g., segmented images 196A-n) comprising respective segmentation masks (e.g., segmentation masks 240A-n) pertaining to the regions of interest (e.g., RoIs 162A-n) in the received tasks/images (e.g., images 160A-n and labels 165A-n), where, as previously described, the segmentation masks are labeled and associated with a label group (e.g., label group 157A-n).

At 840, application of the tasks and label groupings enable the segmentation model to be trained.

At 850, with the segmentation model being modified with the required number of output channels to match the number of label groups, new, unsegmented images (e.g., in subsequently received tasks 150A-n) can be applied to the trained segmentation model to enable respective regions of interest on the new, unsegmented images to be identified based on the previously applied tasks (e.g., where the previously applied tasks comprise tasks associated with sample images 195A-n used to train the segmentation component 120, etc., or received/processed tasks 150A-n after which the segmentation component 120 undergoes further retraining).

At 860, knowledge generated by reviewing the newly segmented images can be reapplied to the training tasks and label groups to facilitate further retraining of the segmentation model as required.

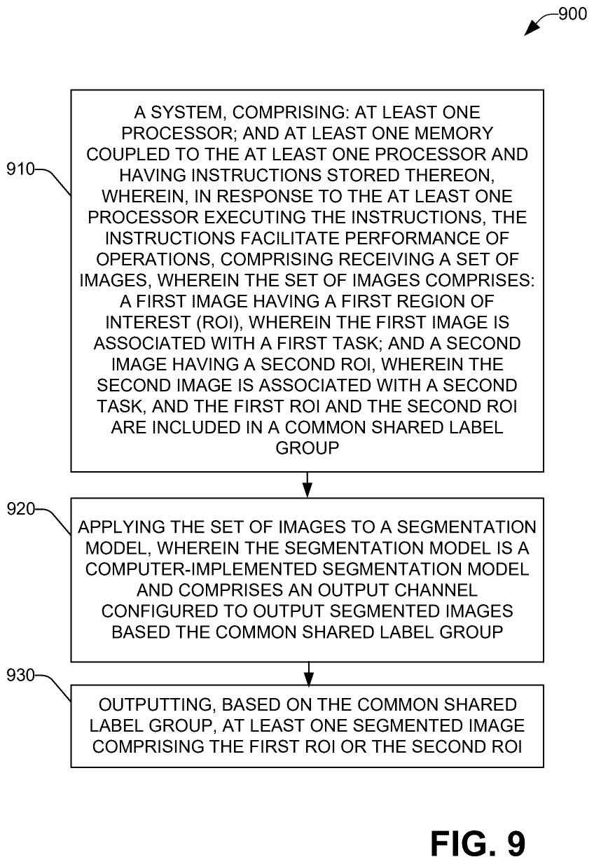

FIG. 9, via flowchart 900, presents an example computer-implemented method for utilizing label sharing in an image segmentation process, in accordance with an embodiment.

At 910, the method 900 can be implemented by a system (e.g., segmentation system 110), at least one processor, and at least one memory coupled to the at least one processor and having instructions stored thereon, wherein, in response to the at least one processor executing the instructions, the instructions facilitate performance of operations, comprising receiving a set of images (e.g., images 160A-n), wherein the set of images comprises: a first image (e.g., image 160A) having a first region of interest (e.g., RoI 162A), wherein the first image is associated with a first task (e.g., task 150A); and a second image (e.g., image 160B) having a second RoI (e.g., RoI 162B), wherein the second image is associated with a second task (e.g., task 150B), and the first RoI and the second RoI are included in a common shared label group (e.g., shared label group 157A).

At 920, the operations of method 900 can further applying the set of images to a segmentation model (e.g., segmentation model 125A), wherein the segmentation model is a computer-implemented segmentation model and comprises an output channel (e.g., channel 260A) configured to output segmented images based the common shared label group.

At 930, outputting, based on the common shared label group, at least one segmented image (e.g., images 196A-n) comprising the first RoI or the second RoI.

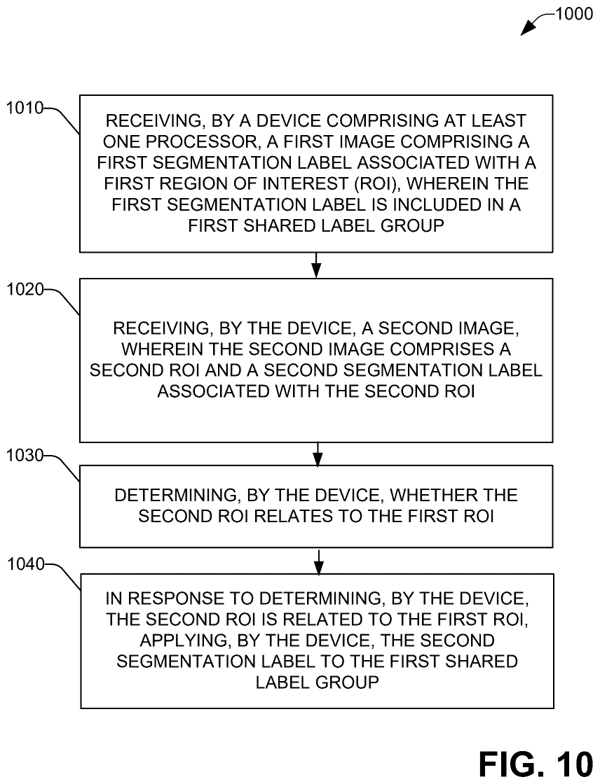

FIG. 10, via flowchart 1000, presents an example computer-implemented method for utilizing label sharing in an image segmentation process, in accordance with an embodiment.

At 1010, the method 1000 can comprise receiving, by a device (e.g., segmentation system 110) comprising at least one processor (e.g., processor 182), a first image (e.g., image 160A) comprising a first segmentation label (e.g., segmentation 165A) associated with a first region of interest (e.g., RoI 162A), wherein the first segmentation label is included in a first shared label group (e.g., shared label group 157A).

At 1020, the method 1000 can further comprise receiving, by the device, a second image, wherein the second image comprises a second RoI (e.g., RoI 162B) and a second segmentation label (e.g., segmentation label 165B) associated with the second RoI.

At 1030, the method 1000 can further comprise determining, by the device, whether the second RoI relates to the first RoI.

At 1040, the method 1000 can further comprise, in response to determining, by the device, the second region of interest is related to the first region of interest, applying, by the device, the second segmentation label to the first common label group.

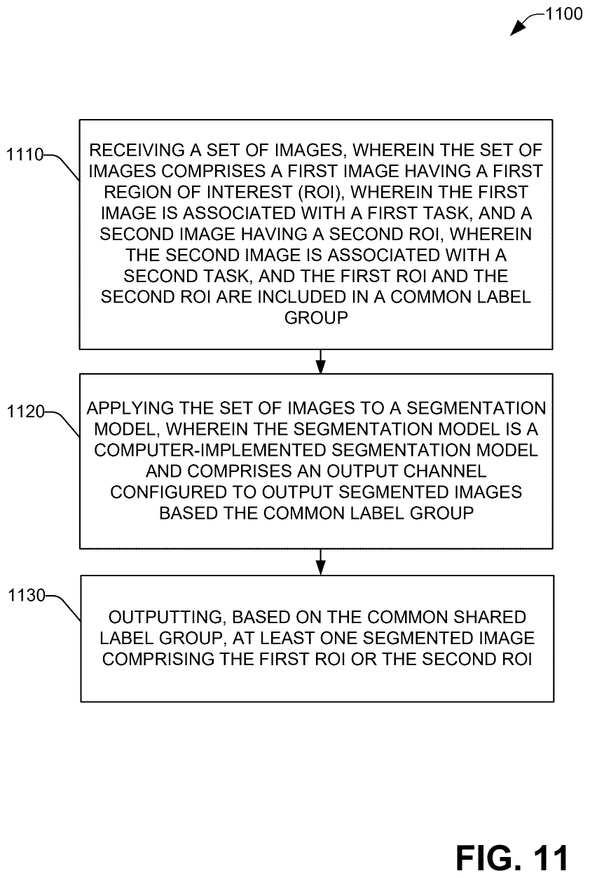

FIG. 11, via flowchart 1100, presents an example computer-implemented method for utilizing label sharing in an image segmentation process, in accordance with an embodiment.

At 1110, the method 1100 can be performed by a computer program product stored on a non-transitory computer-readable medium and comprising machine-executable instructions, wherein, in response to being executed, the machine-executable instructions cause a system to perform operations, comprising receiving a set of images, wherein the set of images comprises: a first image (e.g., image 160A) having a first region of interest (e.g., RoI 162A), wherein the first image is associated with a first task, and a second image (e.g., image 160B) having a second RoI, wherein the second image is associated with a second task (e.g., task 150B), and the first RoI and the second RoI are included in a common label group (e.g., shared label group 157A).

At 1120, the method 1100 can further comprise applying the set of images to a segmentation model (e.g., segmentation model 125A), wherein the segmentation model is a computer-implemented segmentation model and comprises an output channel (e.g., channel 260A) configured to output segmented images (e.g., segmented images 196A-n) based the common label group.

At 1130, the method 1100 can further comprise outputting, based on the common shared label group, at least one segmented image comprising the first RoI or the second RoI.

As used herein, the terms “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Per the various embodiments presented herein, various components included in segmentation system 110, segmentation component 120, segmentation model 125A-n, match component 130, process component 170, and suchlike, can include AI/ML and reasoning techniques and technologies (e.g., processes 176A-n) that employ probabilistic and/or statistical-based analysis to prognose or infer an action that a user desires to be automatically performed. The various embodiments presented herein can utilize various machine learning-based schemes for carrying out various aspects thereof. For example, a process 176A-n (e.g., by match component 130, segmentation component 120) for automatically grouping tasks 150A-n by label groups 157A-n, automatically modifying segmentation model 125A-n, and further automatically generating segmented images 196A-n with the segmentation model 125A-n, and suchlike, as previously mentioned herein, can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed (e.g., identifying label groups 157A-n, and operations related thereto).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria, content in tasks 150A-n, images 160A-n, RoIs 162A-n, labels 165A-n, label groups 157A-n, sample images 195A-n, and modify the segmentation model 125A-n (e.g., with correct number of output channels 260A-n for example).

As described supra, inferences can be made, and automated operations performed, based on numerous pieces of information. For example, whether sufficient context is available to infer, with a high degree of confidence, a correlation between labels 165A-n, and associated RoIs 162A-n, to generate the label groups 157A-n, modify the segmentation model 125A-n, and suchlike.

### Example Applications and Use

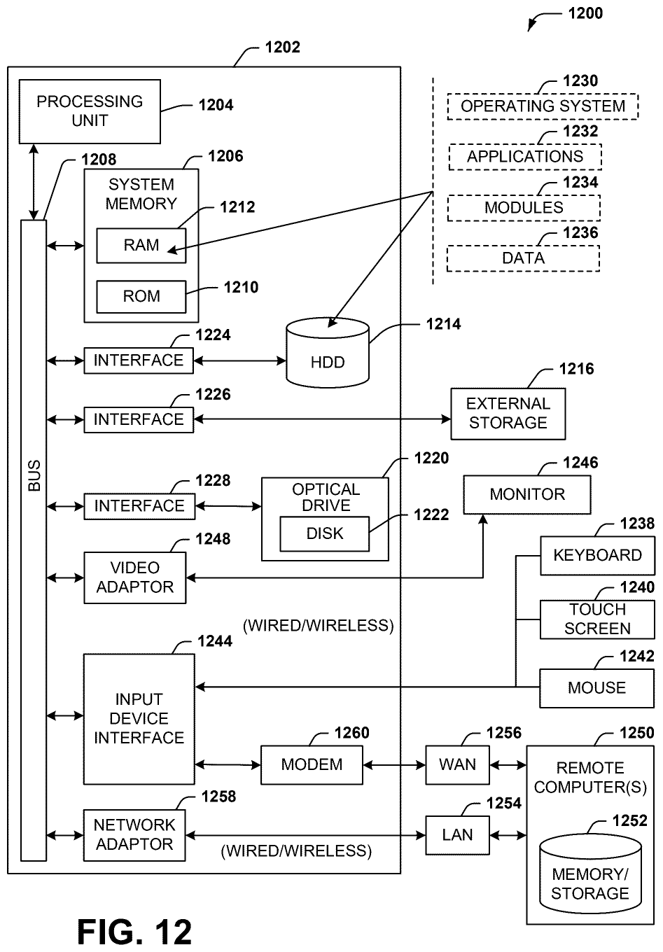

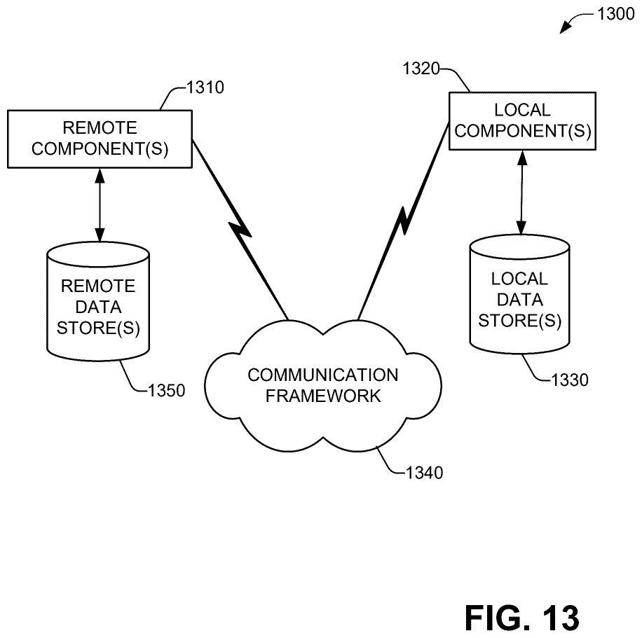

Turning next to FIGS. 12 and 13, a detailed description is provided of additional context for the one or more embodiments described herein with FIGS. 1-11.

In order to provide additional context for various embodiments described herein, FIG. 12 and the following discussion are intended to provide a brief, general description of a suitable computing environment 1200 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors and may include a cache memory. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid-state drive (SSD) could be used in addition to, or in place of, an HDD 1214. The HDD 1214, external storage device(s) 1216 and optical disk drive 1222 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can comprise a security module, such as a trusted processing module (TPM). For instance with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

Referring now to details of one or more elements illustrated at FIG. 13, an illustrative cloud computing environment 1300 is depicted. FIG. 13 is a schematic block diagram of a computing environment 1300 with which the disclosed subject matter can interact. The system 1300 comprises one or more remote component(s) 1310. The remote component(s) 1310 can be hardware and/or software (e.g., threads, processes, computing devices). In some embodiments, remote component(s) 1310 can be a distributed computer system, connected to a local automatic scaling component and/or programs that use the resources of a distributed computer system, via communication framework 1340. Communication framework 1340 can comprise wired network devices, wireless network devices, mobile devices, wearable devices, radio access network devices, gateway devices, femtocell devices, servers, etc.

The system 1300 also comprises one or more local component(s) 1320. The local component(s) 1320 can be hardware and/or software (e.g., threads, processes, computing devices). In some embodiments, local component(s) 1320 can comprise an automatic scaling component and/or programs that communicate/use the remote resources 1310 and 1320, etc., connected to a remotely located distributed computing system via communication framework 1340.

One possible communication between a remote component(s) 1310 and a local component(s) 1320 can be in the form of a data packet adapted to be transmitted between two or more computer processes. Another possible communication between a remote component(s) 1310 and a local component(s) 1320 can be in the form of circuit-switched data adapted to be transmitted between two or more computer processes in radio time slots. The system 1300 comprises a communication framework 1340 that can be employed to facilitate communications between the remote component(s) 1310 and the local component(s) 1320, and can comprise an air interface, e.g., Uu interface of a UMTS network, via a long-term evolution (LTE) network, etc. Remote component(s) 1310 can be operably connected to one or more remote data store(s) 1350, such as a hard drive, solid state drive, SIM card, device memory, etc., that can be employed to store information on the remote component(s) 1310 side of communication framework 1340. Similarly, local component(s) 1320 can be operably connected to one or more local data store(s) 1330, that can be employed to store information on the local component(s) 1320 side of communication framework 1340.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “client entity,” “consumer,” “client entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G or other next generation networks, the disclosed aspects are not limited to a 5G implementation, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

It is to be understood that when an element is referred to as being “coupled” to another element, it can describe one or more different types of coupling including, but not limited to, chemical coupling, communicative coupling, electrical coupling, electromagnetic coupling, operative coupling, optical coupling, physical coupling, thermal coupling, and/or another type of coupling. Likewise, it is to be understood that when an element is referred to as being “connected” to another element, it can describe one or more different types of connecting including, but not limited to, electrical connecting, electromagnetic connecting, operative connecting, optical connecting, physical connecting, thermal connecting, and/or another type of connecting.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory coupled to the at least one processor and having instructions stored thereon, wherein, in response to the at least one processor executing the instructions, the instructions facilitate performance of operations, comprising:
receiving a set of images, wherein the set of images comprises:
a first image having a first region of interest (RoI), wherein the first image is associated with a first task; and
a second image having a second RoI, wherein the second image is associated with a second task, and the first RoI and the second RoI are included in a common shared label group;
applying the set of images to a segmentation model, wherein the segmentation model is a computer-implemented segmentation model and comprises an output channel configured to output segmented images based the common shared label group; and
outputting, based on the common shared label group, at least one segmented image comprising the first RoI or the second RoI.

2. The system of claim 1, wherein the common label group is a first label group, the output channel is a first output channel, and at least one segmented image is included in a first set of segmented images, wherein the operations further comprise:
receiving a second set of images sharing a second shared label group, wherein the first shared label group and the second shared label group are disparate, and the second set of images comprises:
a third image having a third RoI, wherein the third image is associated with the first task; and
a fourth image having a fourth RoI, wherein the fourth image is associated with the second task, and the third RoI and the fourth RoI are included in a second shared label group;
applying the second set of images to the segmentation model, wherein the segmentation model further comprises a second output channel configured to output segmented images based on the second shared label group; and
outputting, based on the second shared label group, at least one segmented image comprising the third RoI or the fourth RoI.

3. The system of claim 2, wherein an architecture of the segmentation model is common to application of two or more segmentation tasks and generation of segmented images based on the first shared label group and the second shared label group.

4. The system of claim 2, wherein a set of common weightings are applied during creation of both the first shared label group and the second shared label group during application of two or more segmentation tasks.

5. The system of claim 2, wherein labels in the first shared label group are disparate to the labels in the second shared label group.

6. The system of claim 2, wherein the operations further comprise:
determining a first number of shared label groups in the first task and a second number of shared label groups in the second task; and
in response to a determination that the first number of shared label groups is different to the second number of shared label groups, configuring the number of output channels of the segmentation model to equal the greater of the first number of shared label groups or the second number of shared label groups.

7. The system of claim 1, wherein the operations further comprise generating the common shared label group as a function of at least one similarity between the at least two images.

8. The system of claim 1, wherein the operations further comprise:
applying a third task to the segmentation model;
generating at least one shared label group from the third task, wherein the at least one shared label group includes the common shared label group; and
training the segmentation model across multiple tasks incrementally utilizing any of the at least two images or the common shared label group.

9. The system of claim 8, wherein the operations further comprise:
subsequently applying a subsequent task to the segmentation model to facilitate incremental training of the segmentation model over a series of iterations to adapt the segmentation model to the subsequent task; and
maintaining incremental training until determining convergence has occurred.

10. The system of claim 9, wherein the operations further comprise:
re-applying a prior task to the converged segmentation model to prevent catastrophic forgetting of the prior task as a function of the segmentation model being converged with the subsequent task.

11. A computer-implemented method, comprising:
receiving, by a device comprising at least one processor, a first image comprising a first segmentation label associated with a first region of interest (RoI), wherein the first segmentation label is included in a first shared label group;
receiving, by the device, a second image, wherein the second image comprises a second RoI and a second segmentation label associated with the second RoI;
determining, by the device, whether the second RoI relates to the first RoI; and
in response to determining, by the device, the second RoI is related to the first RoI, applying, by the device, the second segmentation label to the first shared label group.

12. The computer-implemented method of claim 11, wherein the first shared label group is associated with a first channel assigned to a segmentation model implemented by the device, wherein the segmentation model is implemented by the device to determine the second RoI is related to the first RoI.

13. The computer-implemented method of claim 12, wherein, in response to determining by the device, the second RoI is unrelated to the first RoI, the computer-implemented method further comprising:
identifying, by the device, a third image comprising a third segmentation label, wherein the third segmentation label is associated with a third RoI and the third segmentation label is included in a second shared label group;
determining, by the device, the second RoI relates to the third RoI; and
applying the second segmentation label to the second shared label group, wherein the second shared label group is associated with a second channel assigned to the segmentation model implemented by the device, wherein the segmentation model is implemented by the device to determine the second RoI is related to the third RoI.

14. The computer-implemented method of claim 13, wherein, in response to determining by the device, the second RoI is unrelated to the first RoI and is also unrelated to the third RoI, the computer-implemented method further comprising:
updating, by the device, the segmentation model to include a third channel, wherein the third channel is assigned with a third shared label group; and
assigning the second segmentation label to the third shared label group.

15. The computer-implemented method of claim 12, wherein the segmentation model is a U-net model.

16. The computer-implemented method of claim 11, wherein the determination, by the device, of the second RoI relates to the first RoI is based on at least one of similarity of shape of the first RoI to the second RoI, pixel level between the first RoI and the second RoI, or patch level between a first region of interest (RoI) and a secondRoI.

17. A computer program product stored on a non-transitory computer-readable medium and comprising machine-executable instructions, wherein, in response to being executed, the machine-executable instructions cause a system to perform operations, comprising:
receiving a set of images, wherein the set of images comprises:
a first image having a first region of interest (RoI), wherein the first image is associated with a first task; and
a second image having a second RoI, wherein the second image is associated with a second task, and the first RoI and the second RoI are included in a common label group;
applying the set of images to a segmentation model, wherein the segmentation model is a computer-implemented segmentation model and comprises an output channel configured to output segmented images based the common label group; and
outputting, based on the common shared label group, at least one segmented image comprising the first RoI or the second RoI.

18. The computer program product of claim 17, wherein the set of images in the task comprise medical images.

19. The computer program product of claim 17, wherein the first RoI being related to the second RoI is based on at least one of similarity of shape of the first RoI to the second RoI, pixel level between the first RoI and the second RoI, or patch level between a first RoI and a second RoI.

20. The computer program product of claim 17, wherein the operations further comprising defining the number of output channels prior to generating the set of shared label groups.
